(19) United States
(12) Patent Application Publication
(10) Pub. No.: US 2017/0370543 A1
(43) Pub. Date: Dec. 28, 2017

(54) VEHICLE HEADLAMP AND LIGHT SOURCE UNIT

(71) Applicant: KOITO MANUFACTURING CO., LTD., Tokyo (JP)

(72) Inventor: Hiroki MATSUMOTO, Shizuoka-shi (JP)

(73) Assignee: KOITO MANUFACTURING CO., LTD., Tokyo (JP)

(21) Appl. No.: 15/632,844

(22) Filed: Jun. 26, 2017

(30) Foreign Application Priority Data
Jun. 27, 2016 (JP) 2016-126335

(51) Int. Cl. F21S 8/10

(52) U.S. Cl. CPC F21S 48/1104; F21S 48/328; F21S 48/13; F21S 48/1305

(57) ABSTRACT

A vehicle headlamp includes a lamp chamber and a light source unit. The lamp chamber is defined by assembling a front cover at a front opening portion of a container-shaped lamp body. The light source unit is configured such that a light emitting element that is a light source and a reflector that reflects light emitted from the light emitting element toward a front of the lamp chamber are integrally mounted on an upper surface of a metallic base plate constituting a heat sink in cooperation with a plurality of heat-dissipation fins extending from a lower surface of the base plate, the light source unit arranged in the lamp chamber. The heat-dissipation fins are arranged in parallel in a left and right direction of the base plate and are formed in a substantially L shape in a side view extending in a front and rear direction from a front side of the base plate to a rear upper side of the base plate.

### CROSS-REFERENCE TO RELATED APPLICATION

This application claims priority from Japanese Patent Application No. 2016-126335 filed on Jun. 27, 2016, the entire contents of which are incorporated herein by reference.

### FIELD

The present invention relates to a vehicle headlamp in which a light source unit where a light emitting element that is a light source and a reflector that reflects light emitted from the light emitting element toward the front are mounted integrally on a heat sink is accommodated in a lamp chamber defined by a lamp body and a front cover. Here, the light emitting element means an element-like light source having a light-emitting part that emits light in a substantially point-like manner. The type of the light emitting element is not particularly limited. For example, a light emitting diode or a laser diode or the like can be adopted.

### BACKGROUND

Recently, a vehicle headlamp has been variously proposed as a structure in which a light source unit provided for light distribution formation and having a light emitting element as a light source is accommodated in a lamp chamber in order to reduce power consumption. Thus, a light emitting element capable of obtaining high luminous flux corresponding to the luminosity necessary for light distribution of a headlamp has been developed. However, in this case, the amount of heat generated by the light emitting element has become a problem. That is, in the light emitting element corresponding to the high luminous flux, the high luminous flux is obtained, whereas the amount of generated heat is correspondingly increased. As a result, there occur problems such as a decrease in luminous efficiency or a change in luminescent color.

For these reasons, various structures for increasing the cooling effect of the light emitting element have been proposed. For example, as disclosed in Japanese Patent Laid-Open Publication No. 2010-153333 (see FIGS. 2 and 4), a heat sink 9 is configured such that heat-dissipation fins 11 are formed behind a base plate 10 on which a light emitting element 3 and a reflector 2 are mounted, and thus, the heat generated by the light emitting element 3 is dissipated to the rear side of the heat sink 9.

Further, as disclosed in Japanese Patent Laid-Open Publication No. 2014-146463 (see FIG. 1), a cooling fan 12 is provided so as to directly face heat-dissipation fins 15 of a heat sink 11 on which a light emitting element 14 and a reflector 10 are mounted, thereby promoting the heat-dissipation.

However, in the above Patent Document 1, it is necessary to enlarge the heat-dissipation fins 11 of the heat sink 9 in order to increase the cooling effect of the light emitting element. Thus, the front-rear length of the light source unit is increased. However, there is a limit in relation to an accommodation space of the light source unit in a lamp chamber.

Further, in the above Patent Document 2, the cooling effect is increased by the flow of air generated by the cooling fan 12 without enlarging the heat-dissipation fins 15. However, the number of parts constituting the light source unit is increased. Accordingly, the configuration becomes complicated, the weight is increased, and the cost is also increased.

### SUMMARY

The present invention has been made in view of the above-described problems of the prior art and an object thereof is to provide a vehicle headlamp including a light source unit which is not provided with a cooling fan but is compact and excellent in the cooling effect of a light emitting element.

In order to achieve the above object, first aspect of embodiments provides a vehicle headlamp comprising: a lamp chamber defined by assembling a front cover at a front opening portion of a container-shaped lamp body; a light source unit configured such that a light emitting element that is a light source and a reflector that reflects light emitted from the light emitting element toward a front of the lamp chamber are integrally mounted on an upper surface of a metallic base plate constituting a heat sink in cooperation with a plurality of heat-dissipation fins extending from a lower surface of the base plate, the light source unit arranged in the lamp chamber, wherein the heat-dissipation fins are arranged in parallel in a left and right direction of the base plate and are formed in a substantially L shape in a side view extending in a front and rear direction from a front side of the base plate to a rear upper side of the base plate.

(Function)

The heat of the light emitting element is transferred to the heat-dissipation fins via the base plate of the heat sink and is dissipated from the heat-dissipation fins into the air. The heat-dissipation fins are adjacent to each other in the left and right direction of the base plate and extend in a substantially L shape in a side view from the front side to the lower side and the rear upper side of the base plate, and the heat-dissipation area of the heat sink (heat-dissipation fins) is large. That is, as compared with a conventional heat sink (a structure in which the heat-dissipation fins are formed on the lower side or the rear side of the base plate), the heat sink (heat-dissipation fins) of the present invention has a larger heat-dissipation area and is also excellent in the cooling effect of the light emitting element.

Particularly, the distances from the heat-dissipation fins extending on the front side of the base plate and the heat-dissipation fins extending on the rear side of the base plate to the light emitting element on the base plate are substantially the same, and the heat can be almost uniformly dissipated from the lower side, the front side and the rear side of the heat sink. As a result, the cooling effect of the light emitting element is correspondingly excellent and the light emitting element can be effectively cooled without adopting large heat-dissipation fins or an air-cooling fan.

In addition to first aspect of embodiments, second aspect of embodiments has a configuration that the base plate is disposed to be inclined forward or rearward.

(Function)

The heat of the light emitting element that is a light source is dissipated into the air from the heat-dissipation fins formed in a substantially L shape in a side view extending from the front side to the rear upper side of the base plate. When the base plate is horizontally disposed, the heat of the light emitting element is uniformly transferred from the light emitting element mounting position of the base plate in a radial direction in a plan view. That is, the heat transfer amount is constant at any position around the light emitting element. However, when the base plate is inclined, the heat transfer amount in the inclined direction is smaller than that in the opposite direction. In other words, the movement (transfer) of heat is promoted in the direction opposite to the direction in which the base plate is inclined.

For these reason, in second aspect of embodiments, the base plate is made to be inclined in the front and rear direction. Although the total amount of heat transferred from the light emitting element to the heat-dissipation fins via the base plate is the same, the movement (transfer) of heat to the rear side (front side) of the base plate is promoted in a form in which the base plate is inclined forward (rearward). As a result, the heat-dissipation amount from the heat-dissipation fins extending on the rear side (front side) of the base plate is increased, as compared with the heat-dissipation amount from the heat-dissipation fins extending on the front side (rear side) of the base plate.

Furthermore, as the warmed air on the lower surface of the base plate ascends along the lower surface of the base plate inclined, the flow of air is generated in an air passage which is constituted by the heat-dissipation fins extending from the lower surface to the front side and the rear upper side of the base plate and which has a substantially L shape in a side view extending in the front and rear direction. This flow of air increases the heat-dissipation of the heat sink.

For example, in the case where there is a difference in the heat-dissipation area of the heat-dissipation fins formed respectively at the front and rear of the base plate due to the difference in the number and size of the heat-dissipation fins, the base plate is disposed to be inclined (forward or rearward) in the front and rear direction so that more (less) heat is transferred to the heat-dissipation fins with a larger (smaller) heat-dissipation area. In this way, the cooling effect of the light emitting element can be increased.

In addition to second aspect of embodiments, third aspect of embodiments has a configuration that the base plate of the heat sink is disposed to be inclined rearward, front edge portions of the heat-dissipation fins extending on the front side of the base plate are brought into contact with another constituent member of the light source unit disposed adjacent to a front of the heat sink or are integrated with an upright wall extending in the left and right direction, and a chimney is provided in an air passage constituted by the heat-dissipation fins extending on the front side of the base plate.

(Function)

A front air passage formed by the heat-dissipation fins extending on the front side of the base plate communicates with a rear air passage extending in the up and down direction and formed by the heat-dissipation fins extending on the rear side of the base plate via a lower air passage formed by the heat-dissipation fins extending in the front and rear direction on the lower surface of the base plate. That is, an air passage having a substantially L shape in a side view extending in the front and rear direction is formed by the heat-dissipation fins extending from the lower surface of the base plate to the front side and the rear upper side of the base plate. These heat-dissipation fins have a substantially L shape in a side view and are adjacent to each other in the left and right direction.

Then, by arranging the base plate to be inclined rearward, firstly, the movement of heat to the front side of the heat sink (base plate) is promoted. Secondly, when the air in the lower air passage, which is warmed by taking heat from the heat-dissipation fins extending in the front and rear direction on the lower surface of the base plate, ascends along the lower surface of the base plate inclined rearward, the forward flow of air is generated in the lower air passage. In this way, as indicated by the arrow in FIG. 2, circulating air convection is formed around the heat sink. The air convection vertically turns forward-upward and rearward-downward in the route of the lower air passage→the front air passage→above the reflector→the rear air passage→the lower air passage. As a result, the light emitting element can be effectively cooled.

Furthermore, the flow of air flowing upward along the front air passage is accelerated by the chimney effect of the front air passage formed by the heat-dissipation fins extending on the front side of the base plate. In this way, the circulating air convection, which is formed around the heat sink and vertically turns forward-upward and rearward-downward, becomes active. As a result, the light emitting element can be more effectively cooled.

In addition to any one of first to third aspects of embodiments, fourth aspect of embodiments has a configuration that the base plate is formed in an L-shaped longitudinal section, a vertical rod-shaped portion of the L-shaped longitudinal section of the base plate is formed in a substantially circular arc shape in a plan view surrounding the light emitting element, out of the plurality of heat-dissipation fins extending rearward from a back side of the vertical rod-shaped portion of the L-shaped longitudinal section of the base plate, at least the heat-dissipation fins closer to both sides in a width direction of the base plate extend in a radial direction with respect to the light emitting element, and extended ends of the plurality of heat-dissipation fins are arranged along a substantially circular arc shape in a plan view to follow a substantially circular arc shape in a plan view of the vertical rod-shaped portion of the L-shaped longitudinal section of the base plate.

(Function)

A large number of heat-dissipation fins extend rearward from the vertical rod-shaped portion of the L-shaped longitudinal section of the base plate formed in the L-shaped longitudinal section. The distances from the light emitting element to the rear extended ends of the respective heat-dissipation fins are substantially the same. Therefore, the amount of heat transferred from the base plate to the respective heat-dissipation fins extending rearward and the amount of heat dissipated from the respective heat-dissipation fins into the air are uniformly distributed. As a result, the heat-dissipation effect to the rear side of the heat sink is increased.

Particularly, in the region where the heat-dissipation fins extend from the vertical rod-shaped portion of the L-shaped longitudinal section of the base plate in the radial direction with respect to the light emitting element, gaps between the heat-dissipation fins adjacent to each other in a circumferential direction are enlarged toward the extended ends of the heat-dissipation fins, and thus, the flow of air in the rear air passage formed between the adjacent heat-dissipation fins and extending in the up and down direction becomes smooth. As a result, the heat-dissipation effect to the rear side of the heat sink is correspondingly increased.

Further, since the rear extended ends of the heat-dissipation fins extending rearward from the vertical rod-shaped portion of the L-shaped longitudinal section of the base plate are arranged along a substantially circular arc shape in a plan view to follow a substantially circular arc shape in a plan view of the vertical rod-shaped portion of the L-shaped longitudinal section of the base plate, the rear shape of the heat sink, i.e., the rear shape of the light source unit is formed in a substantially circular arc shape in a plan view surrounding the light emitting element. Therefore, a swinging radius of the light source unit is reduced when an aiming operation or a swivel driving of the light source unit is performed. Correspondingly, the light source unit hardly interferes with the lamp body or another lamp constituent member disposed near the light source unit in the lamp chamber.

Fifth aspect of embodiments provides a light source unit in which a light emitting element that is a light source is mounted on an upper surface of a metallic base plate constituting a heat sink in cooperation with a plurality of heat-dissipation fins extending from a lower surface of the base plate, wherein the heat-dissipation fins are arranged in parallel in a predetermined direction of the base plate and are formed in a substantially L shape in a side view extending beyond the base plate in a direction orthogonal to an arrangement direction.

(Function)

The heat of the light emitting element is transferred to the heat-dissipation fins via the base plate of the heat sink and is dissipated from the heat-dissipation fins into the air. The heat-dissipation fins are adjacent to each other in the arrangement direction and are formed in a substantially L shape in a side view extending beyond the base plate in the direction orthogonal to the arrangement direction. Therefore, the heat-dissipation area of the heat sink (heat-dissipation fins) is large. That is, as compared with a conventional heat sink (a structure in which the heat-dissipation fins are formed on the lower side or the rear side of the base plate), the heat sink (heat-dissipation fins) of the present invention has a larger heat-dissipation area and is also excellent in the cooling effect of the light emitting element.

In particular, the distances from the portion of the heat-dissipation fins extending beyond the base plate to the light emitting element on the base plate are substantially the same and the heat can be almost uniformly dissipated from the entire of the heat-dissipation fins having a substantially L shape in a side view. Thus, the cooling effect of the light emitting element is correspondingly excellent and the light emitting element can be effectively cooled without adopting large heat-dissipation fins or an air-cooling fan.

As is apparent from the above description, according to first aspect of embodiments, the vehicle headlamp including the light source unit which is not provided with a cooling fan but is compact and excellent in the cooling effect of the light emitting element can be provided at low cost.

According to second aspect of embodiments, the heat sink is disposed to be inclined forward or rearward in accordance with the specification (characteristic) of the heat sink, i.e., whether the heat is positively dissipated from either the front side or the rear side of the heat sink. In this way, the light emitting element can be effectively cooled.

According to third aspect of embodiments, the active circulating air convection, which vertically turns forward-upward and rearward-downward, is formed around the heat sink of the light source unit. In this way, the light emitting element can be more effectively cooled.

According to fourth aspect of embodiments, it is possible to provide the vehicle headlamp which is excellent in the heat-dissipation to the rear side of the heat sink and is correspondingly excellent in the cooling effect of the light emitting element and in which the aiming operation or swivel operation of the light source unit can be smoothly performed.

According to fifth aspect of embodiments, it is possible to provide the light source unit which is not provided with a cooling fan but is compact and excellent in the cooling effect of the light emitting element.

### BRIEF DESCRIPTION OF DRAWINGS

FIG. 1 is a front view of an automobile headlamp according to a first embodiment of the present invention.

FIG. 2 is a longitudinal sectional view of the headlamp, taken along the line II-II shown in FIG. 1.

FIG. 3 is a plan view of a light source unit that is a main part of the headlamp.

FIG. 4 is a bottom view of the light source unit.

FIG. 5 is a back perspective view of the light source unit.

FIG. 6 is an exploded perspective view of the light source unit.

FIG. 7 is a longitudinal sectional view of an automobile headlamp according to a second embodiment of the present invention.

FIG. 8 is a perspective view of a heat sink integrated with a light source unit that is a main part of the headlamp.

### DETAILED DESCRIPTION

Next, embodiments of the present invention will be described on the basis of examples.

In FIGS. 1 to 6 showing an automobile headlamp 10 according to an example of the present invention, the automobile headlamp 10 is configured in such a way that a projection type light source unit 20 having a light emitting element (LED for high luminous flux) 22 as a light source is accommodated in a lamp chamber defined by a container-shaped lamp body 12 opened on the front side and a plain translucent cover (front cover) 14 attached to the front opening portion.

The light source unit 20 includes an aluminum die-cast heat sink 30 in which a large number of heat-dissipation fins 34 extend from a base plate 31 having an L-shaped longitudinal section. The light emitting element (LED for high luminous flux) 22 that is a light source and a resin reflector 24 that reflects light emitted from the light emitting element 22 toward the front side are attached on an upper surface of a horizontal rod-shaped portion (hereinafter, referred to as a “horizontal base plate”) 31a of the L-shaped longitudinal section of the base plate 31.

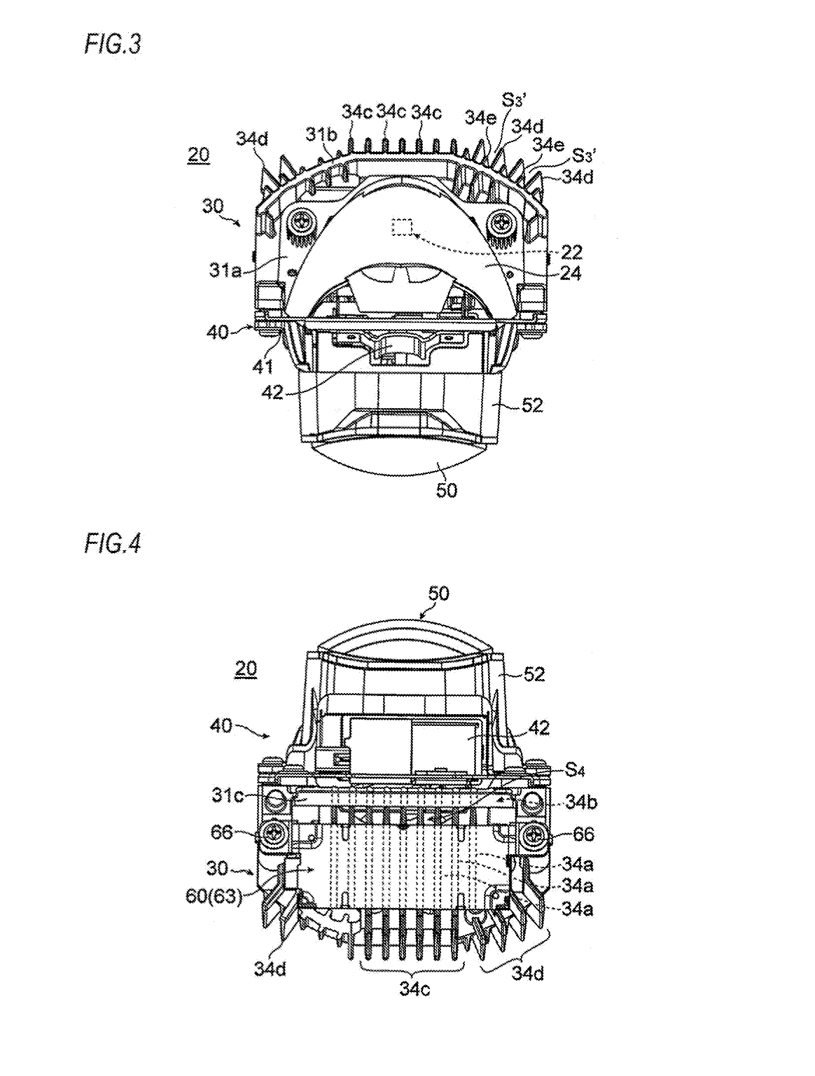

Specifically, a pedestal 32 for attaching the light emitting element is provided at the central portion of the upper surface of the horizontal base plate 31a constituting the heat sink 30. The pedestal 32 has an element mounting surface 32a parallel to upper and lower surfaces of the base plate 31. The light emitting element 22 is attached to the pedestal 32 with its irradiation axis facing upward. The reflector 24 is attached to the rear side of the upper surface of the horizontal base plate 31a and is disposed so as to cover the upper side of the light emitting element 22. As shown in FIGS. 3, 4 and 5, a vertical rod-shaped portion (hereinafter, referred to as a “vertical base plate”) 31b of the L-shaped longitudinal section of the base plate 31 constituting the heat sink 30 is formed in a substantially circular arc shape in a plan view with the pedestal 32 as the center. On the back side of the vertical base plate 31b, heat-dissipation fins 34c, 34d formed to extend rearward at equal intervals in the left and right direction are extended in the up and down direction.

Then, a projection lens 50 made of resin is disposed in front of the heat sink 30. A shade mechanism 40 for switching light distribution is arranged between the reflector 24 and the projection lens 50. The shade mechanism 40 includes a movable shade 43. These parts are integrated as the light source unit 20.

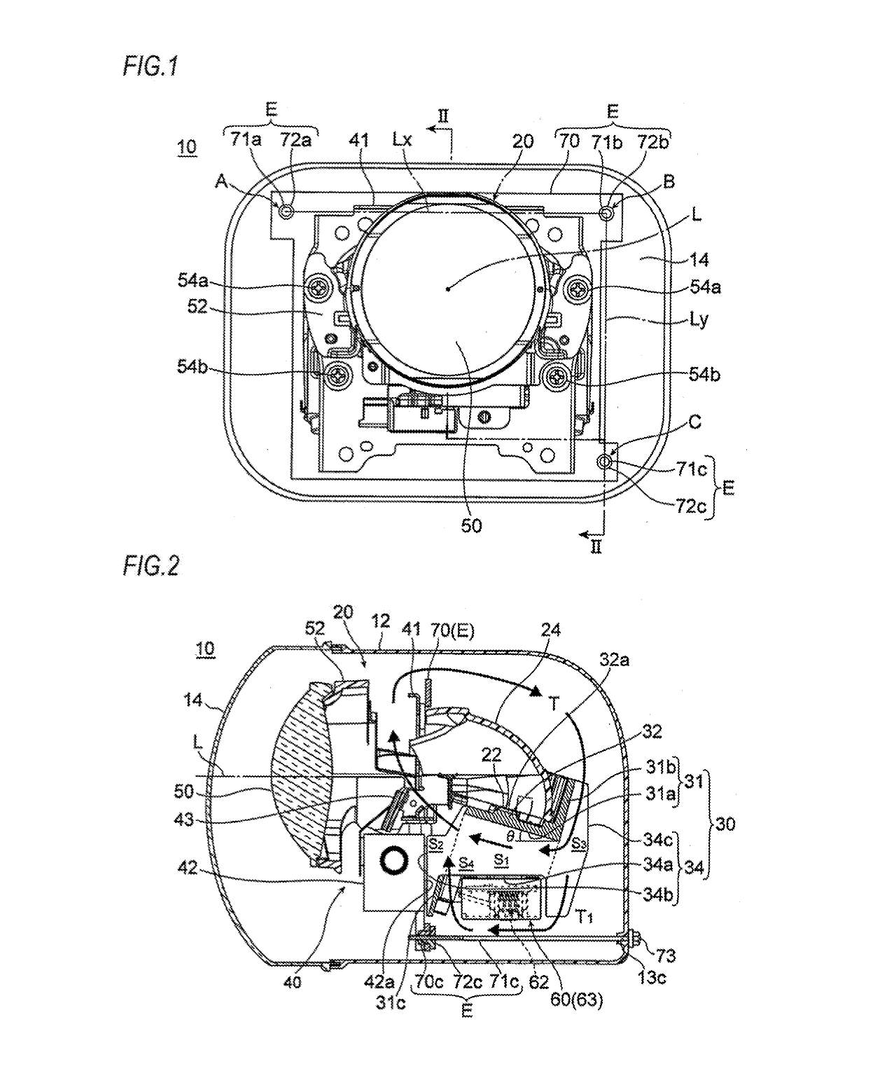

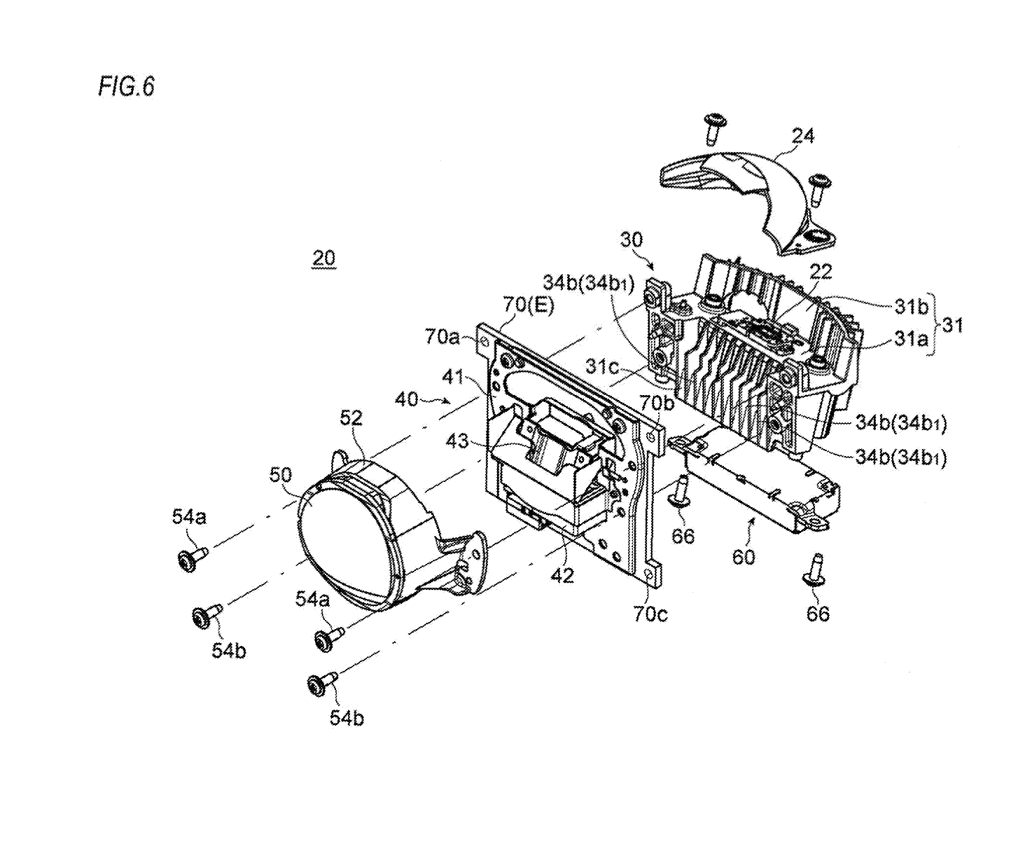

Specifically, as shown in FIG. 6, on the front side of the heat sink 30, a lens holder 52 for holding the projection lens 50 and a support plate 41 constituting the shade mechanism 40 for switching light distribution are fastened and fixed together by two fastening screws 54a. The support plate 41 has a rectangular shape in a front view and is opened on the central portion. The projection lens 50 is disposed on an optical axis L (see FIGS. 1 and 2) of the light source unit 20. Meanwhile, a reference numeral 54b refers to a fastening screw for fixing the support plate 41 of the shade mechanism 40 for switching light distribution to the heat sink 30.

Further, as shown in FIGS. 2, 4 and 6, on the lower surface side of the heat sink 30, a lighting circuit unit 60 for controlling the lighting of the light emitting element 22 is fixed by two screws 66. A lighting circuit 62 is composed of a circuit board on which electronic components (circuit elements) are mounted. The lighting circuit 62 is accommodated in a lighting circuit housing 63 and integrated as the lighting circuit unit 60 (see FIG. 2).

Then, as the movable shade 43 is swung in the front and rear direction by the driving of an electromagnetic solenoid 42 constituting the shade mechanism 40 for switching light distribution, the light distribution formed by the light source unit 20 is switched between a low beam and a travelling beam.

Further, as shown in FIGS. 1 and 2, the light source unit 20 accommodated in the lamp chamber is supported at three points including a pair of aiming points A, B and one aiming point C. The pair of aiming points A, B is spaced apart in the left and right direction on the upper side of the inside of the lamp chamber, and the aiming point C is located almost just below the aiming point B. The light source unit 20 is supported by an aiming mechanism E so as to be tiltable around a horizontal tilt axis Lx passing through the aiming points A, B and a vertical tilt axis Ly passing through the aiming points B, C, respectively.

Specifically, as shown in FIGS. 1 and 2, an aiming bracket 70 is integrally fixed on the back side of the support plate 42 of the shade mechanism 40 for switching light distribution integrated as the light source unit 20. The aiming bracket 70 is provided with holes 70a, 70b, 70c (holes 70a, 70b are not shown) corresponding to the aiming points A, B, C and has a rectangular frame shape that is one size larger than the support plate 41. On the other hand, through-holes 13a, 13b, 13c (through-holes 13a, 13b are not shown) corresponding to the aiming points A, B, C are provided in the back surface wall of the lamp body 10. Aiming screws 71a, 71b, 71c each provided with a pivot operation part 73 are rotatably supported in the through-holes 13a, 13b, 13c and extend into the lamp chamber. Bearing nuts 72a, 72b, 72c are mounted in the holes 70a, 70b, 70c of the bracket 70. The bearing nuts 72a, 72b, 72c are screwed to leading ends of the aiming screws 71a, 71b, 71c, respectively.

That is, the aiming mechanism E is constituted by the aiming bracket 70 for supporting the light source unit 20, the three aiming screws 71a, 71b, 71c and the three bearing nuts 72a, 72b, 72c. The tilting of the optical axis L of the light source unit 20 can be adjusted in the left and right direction (the up and down direction) by a pivoting operation of the aiming screw 71a (71c). Meanwhile, the aiming bracket 70 is not shown in FIGS. 3, 4 and 5.

Further, in the present embodiment, the light emitting element 22 (LED for high luminous flux) 22 corresponding to the luminosity necessary for light distribution of the headlamp is adopted as a light source of the light source unit 20, and thus, the heat generation amount of the light emitting element 22 is large. Therefore, it is necessary to effectively cool the light emitting element 22 and the lighting circuit unit 60 so that the light emitting element 22 and (electronic components of) the lighting circuit 52 are not affected by the heat generated from the light emitting element 22.

Therefore, in the present embodiment, as shown in FIG. 2, the heat-dissipation fins 34 extend in a plate-like manner in the front and rear direction and extend to be equally spaced in the left and right direction (width direction) on the lower surface of the horizontal base plate 31a of the heat sink 30. The heat-dissipation fins 34 are formed in a substantially L shape in a side view from the front lower side to the rear upper side of the horizontal base plate 31a. In this way, a large heat-dissipation area is secured. Further, the lighting circuit unit 60 is disposed at a position immediately below the heat-dissipation fins 34 on the lower side of the horizontal base plate 31a of the heat sink 30. At this position, the lighting circuit unit 60 is unlikely to be affected by the heat of the light emitting element 22 as much as possible.

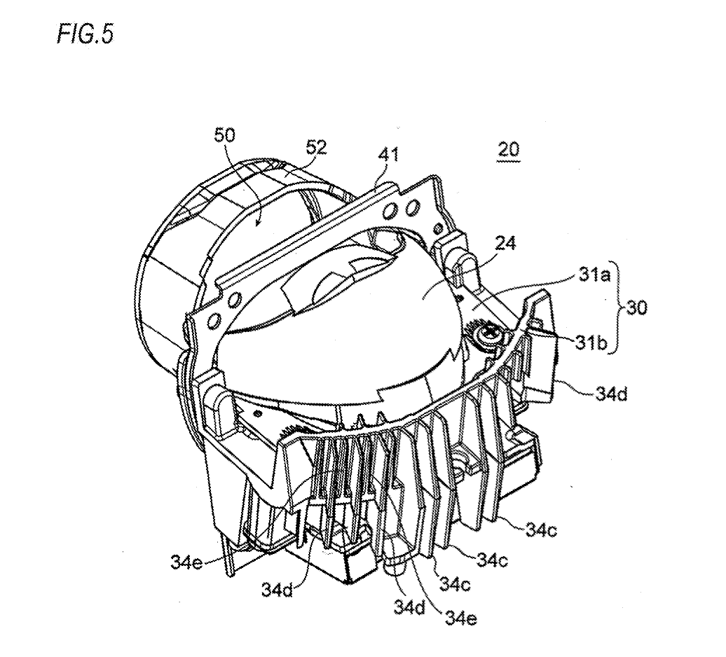

Specifically, as shown in FIGS. 2 and 4, on the lower surface of the horizontal base plate 31a, nine lower heat-dissipation fins 34a are formed at equal intervals in the left and right direction so as to extend in the front and rear direction. Then, the lower heat-dissipation fins 34a are respectively continuous with nine front heat-dissipation fins 34b (see FIGS. 2 and 6) extending substantially in a vertical direction to the front lower side of the horizontal base plate 31a. Further, the lower heat-dissipation fins 34a are continuous with rear heat-dissipation fins 34c, 34d (see FIGS. 2, 3, 4 and 5) extending rearward from the vertical base plate 31b and extending in the up and down direction. That is, the heat-dissipation fins 34 are formed in a plate shape in which the front heat-dissipation fins 34b, the lower heat-dissipation fins 34a and the rear heat-dissipation fins 34c (34d) are integrally continuous. Meanwhile, the nine front heat-dissipation fins 34b formed at equal intervals in the left and right direction are integrally formed with an inclined upright wall 31c (see FIGS. 2, 4 and 6) crossing the rear lower side of the front heat-dissipation fins 34b in the left and right direction, so that the rigidity of the heat-dissipation fins 34 (front heat-dissipation fins 34b) is secured.

Then, the heat of the light emitting element 22 is transferred to the heat-dissipation fins 34 (34a, 34b, 34c, 34d) via the base plate 31 and is dissipated from the heat-dissipation fins 34 into the air. The heat-dissipation fins 34 are adjacent to each other in the left and right direction of the base plate 31 and extend in a substantially L shape in a side view from the front side to the lower side and the rear upper side of the base plate 31. As compared with a conventional heat sink, the heat sink 30 has a larger heat-dissipation area and is excellent in the cooling effect of the light emitting element 22.

In particular, the distances from the front heat-dissipation fins 34b extending on the front lower side of the base plate 31 and the rear heat-dissipation fins 34c, 34d extending in the up and down direction on the rear side of the base plate 31 to the light emitting element 22 on the base plate 31 are substantially the same, and the heat can be almost uniformly dissipated from the lower side, the front side and the rear side of the heat sink 30. As a result, the cooling effect of the light emitting element 22 is correspondingly excellent and the light emitting element 22 can be effectively cooled without adopting large heat-dissipation fins or an air-cooling fan.

Further, as shown in FIG. 2, the heat sink 30 is disposed such that the horizontal base plate 31a is inclined rearward by a predetermined angle θ with respect to the horizontal. Thus, the movement (transfer) of heat to the front side of the heat sink 30 (horizontal base plate 31a) is promoted. Further, front edge portions 34b1 of the front heat-dissipation fins 34b extending on the front lower side of the horizontal base plate 31a are brought into contact with a housing back side 42a of the solenoid 42 of the shade mechanism 40 for switching light distribution disposed adjacent to the front of the heat sink 30, so that a chimney is formed in a front air passage S2 formed by the front heat-dissipation fins 34b and extending in the up and down direction. In this way, circulating air convection T formed around the heat sink 30 becomes active. As a result, the light emitting element 22 and the lighting circuit unit 60 is more effectively cooled.

Hereinafter, the circulating air convection T formed around the heat sink 30 is described.

On the lower side of the horizontal base plate 31a, a lower air passage S1 extending in the front and rear direction is formed by the lower heat-dissipation fins 34a adjacent to each other in the left and right direction (width direction). On the front lower side of the horizontal base plate 31a, the front air passage S2 extending in the up and down direction is formed by the front heat-dissipation fins 34b adjacent to each other in the left and right direction (width direction). On the rear side of the horizontal base plate 31a (the rear side of the vertical base plate 31b), a rear air passage S3 extending in the up and down direction is formed by the rear heat-dissipation fins 34c adjacent to each other in the left and right direction (width direction).

Then, the front air passage S2 communicates with the rear air passage S3 via the lower air passage S1 below the horizontal base plate 31a. That is, the air passages S (S1, S2, S3) extending in the front and rear direction and having a substantially L shape in a side view are formed between the heat-dissipation fins 34 (34a, 34b, 34c, or 34d) extending from the lower side of the horizontal base plate 31a to the front side of the horizontal base plate 31a and the rear side of the vertical base plate 31b. The heat-dissipation fins 34 (34a, 34b, 34c, or 34d) are adjacent to each other in the left and right direction (width direction) and have a substantially L shape in a side view.

Then, by arranging the horizontal base plate 31a of the heat sink 30 to be inclined rearward, firstly, the movement (transfer) of heat to the front side of the heat sink 30 (horizontal base plate 31a) is promoted. Secondly, when the air in the lower air passage S1, which is warmed by taking heat from the front heat-dissipation fins 34b, ascends along the lower surface of the horizontal base plate 31a inclined rearward, the forward flow of air is generated in the lower air passage S1. In this way, as indicated by the arrow in FIG. 2, the circulating air convection T is formed around the heat sink 30. The air convection T vertically turns forward-upward and rearward-downward in the route of the lower air passage S1→the front air passage S2→above the reflector 24→the rear air passage S3→the lower air passage S1. As a result, the light emitting element 22 and the lighting circuit unit 60 are effectively cooled.

Furthermore, the flow of air flowing upward in the front air passage S2 is accelerated by the chimney effect of the front air passage S2 formed by the front heat-dissipation fins 34b of the heat sink 30. In this way, the circulating air convection T formed around the heat sink 30 becomes active. As a result, the light emitting element 22 and the lighting circuit unit 60 are more effectively cooled.

Particularly, the lighting circuit unit 60 is disposed below the horizontal base plate 31a of the heat sink 30. As shown in FIGS. 2 and 4, the lighting circuit unit 60 is disposed near the rear side of the lower heat-dissipation fins 34a, and the lower portion between the lower air passage S1 and the front air passage S2 is opened. Therefore, new air under the heat sink 30 is taken into the front air passage S2 through a lower opening portion S4 of the front air passage S2, so that the chimney effect of the front air passage S2 is further enhanced. That is, the flow of air flowing upward in the front air passage S2 is further accelerated, and thus, circulating air convection T1 (see FIG. 2) is formed. The circulating air convection T1 vertically turns in the route of the lower opening portion S4→the front air passage S2→above the reflector 24→the rear air passage S3→below the lighting circuit unit 60→the lower opening portion S4.

Therefore, the circulating air convection formed around the heat sink 30 and vertically turning forward-upward and rearward-downward becomes more active. As a result, the light emitting element 22 and the lighting circuit unit 60 is more effectively cooled.

Further, as shown in FIGS. 3 and 6, the vertical base plate 31b of the heat sink 30 is formed in a substantially circular arc shape in a plan view surrounding the light emitting element 22. The rear heat-dissipation fins 34c, 34d extending on the back side of the vertical base plate 31b extend downward and are continuous with the lower heat-dissipation fins 34a. Further, as shown in FIGS. 4 and 5, the heat-dissipation fins 34c formed near the central portion in the width direction on the back side of the vertical base plate 31b extend rearward at equal intervals in the left and right direction, and the heat-dissipation fins 34d formed near both sides in the width direction on the back side of the vertical base plate 31b extend in the radial direction with respect to the light emitting element 22. Thus, the extended ends of the heat-dissipation fins 34c, 34d are arranged along a substantially circular arc shape in a plan view to follow a substantially circular arc shape in a plan view of the vertical base plate 31b.

Therefore, since the distances from the light emitting element 22 to the extended ends of the respective heat-dissipation fins 34c, 34d are substantially the same, the amount of heat transferred to the respective heat-dissipation fins 34c, 34d and the amount of heat dissipated from the respective heat-dissipation fins 34c, 34d into the air are uniformly distributed, and thus, the heat-dissipation effect to the rear side of the heat sink 20 is enhanced.

In particular, gaps between the heat-dissipation fins 34d, 34d adjacent to each other in the circumferential direction are enlarged toward the extended ends of the heat-dissipation fins 34d, and thus, the flow of air in a rear air passage S3′ (see FIG. 3) formed between the adjacent heat-dissipation fins 34d, 34d and extending in the up and down direction is smoothly increased. As a result, the heat-dissipation effect to the rear side of the heat sink 30 is correspondingly increased.

Furthermore, heat-dissipation fins 34e extending rearward from the vertical base plate 31b and having a short extending length are provided between the heat-dissipation fins 34d, 34d adjacent to each other in the circumferential direction, and thus, the heat-dissipation area on the back side of the vertical base plate 31b is increased. In this way, the heat-dissipation effect to the rear side of the heat sink 30 is correspondingly increased.

Further, since the rear extended ends of the heat-dissipation fins 34d are arranged along a substantially circular arc shape in a plan view to follow a substantially circular arc shape in a plan view of the vertical base plate 31b, the rear shape of the heat sink 30, i.e., the rear shape of the light source unit 20 is formed in a substantially circular arc shape in a plan view surrounding the light emitting element 22. Therefore, a swinging radius of the light source unit 20 is reduced when an aiming operation of the light source unit 20 is performed. Correspondingly, the light source unit hardly interferes with the lamp body 12 or another lamp constituent member disposed near the light source unit 20 in the lamp chamber.

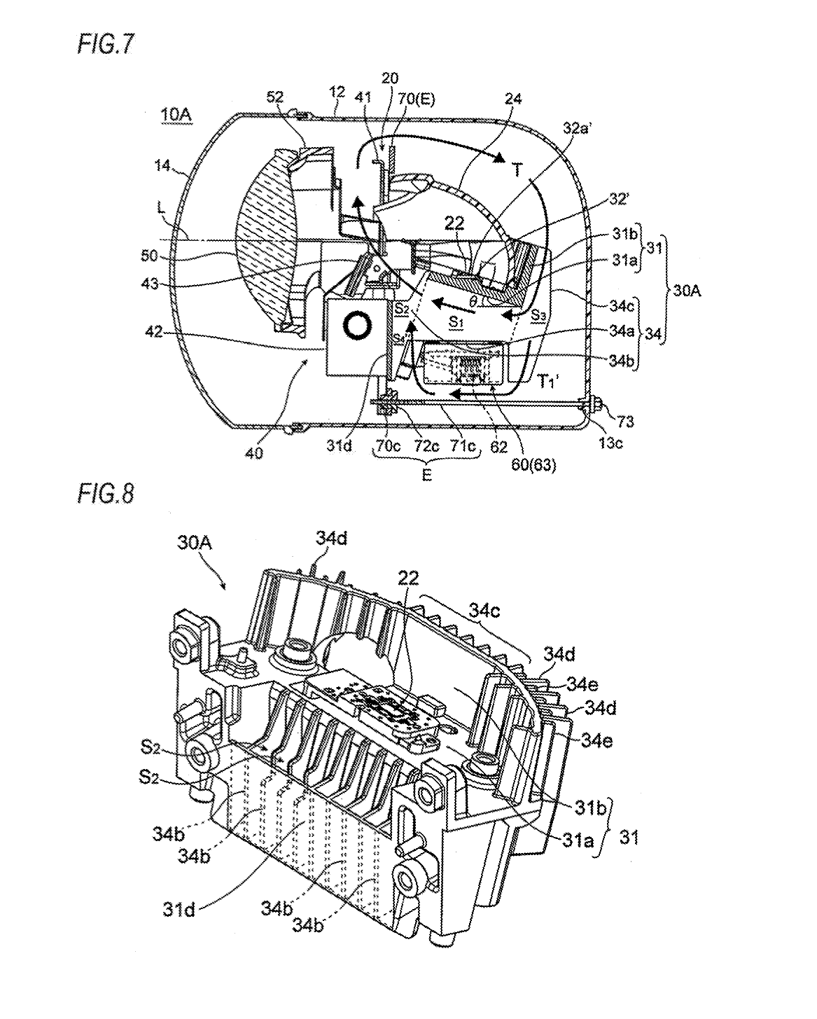

FIGS. 7 and 8 show an automobile headlamp according to a second embodiment of the present invention. FIG. 7 is a longitudinal sectional view of the automobile headlamp, and FIG. 8 is a perspective view of a heat sink integrated with the light source unit that is a main part of the headlamp.

In the headlamp 10 according to the first embodiment described above, the pedestal 32 for attaching the light emitting element is provided on the central portion of the upper surface of the horizontal base plate 31a of the heat sink 30, and the element mounting surface 32a of the pedestal 32 is configured by a surface parallel to the upper and lower surfaces of the horizontal base plate 31a. Therefore, the horizontal base plate 31a is disposed in the lamp chamber to be inclined rearward by the predetermined angle θ with respect to the horizontal, so that the irradiation axis of the light emitting element 22 attached to the pedestal 32 is inclined rearward by the predetermined angle θ (predetermined angle corresponding to the rearward inclination angle of the horizontal base plate 31a).

On the other hand, in a headlamp 10A according to the present embodiment, in the case where the horizontal base plate 31a of a heat sink 30A is disposed in the lamp chamber to be inclined rearward by the predetermined angle θ with respect to the horizontal, an element mounting surface 32a′ of a pedestal 32′ for attaching the light emitting element is horizontal, and thus, the irradiation axis of the light emitting element 22 attached to the pedestal 32′ is vertical.

Further, in the headlamp 10 according to the first embodiment described above, the front edge portions 34b1 of the front heat-dissipation fins 34b of the heat sink 30 are brought into contact with the housing back side 42a of the electromagnetic solenoid 42 of the movable shade mechanism 40 for switching light distribution disposed adjacent to the front of the heat sink 30, so that a chimney is formed in the front air passage S2 of the heat sink 30. On the contrary, in the headlamp 10A according to the present embodiment, an upright wall 31d crossing the front lower side of the horizontal base plate 31a in the left and right direction is formed integrally with the front edge portions of the front heat-dissipation fins 34b of the heat sink 30A, so that a chimney is formed in the front air passage S2 formed by the front heat-dissipation fins 34b.

Further, since the rigidity of the heat-dissipation fins 34 (front heat-dissipation fins 34b) can be secured by the upright wall 31d provided at the front edge side of the front heat-dissipation fins 34d, the inclined upright wall 31c (see FIGS. 2, 4 and 6) provided in the first embodiment is removed.

Therefore, as shown in FIG. 7, a lower opening portion S4′ of the front air passage S2 is largely opened, as compared to the case of the first embodiment described above. New air under the heat sink 30 is more taken into the front air passage S2 through the lower opening portion S4′. Thus, the chimney effect of the front air passage S2 is further enhanced, as compared to the case of the first embodiment. That is, the flow of air flowing upward in the front air passage S2 is further accelerated, so that circulating air convection T1′ (see FIG. 7) becomes more active. The circulating air convection T1′ vertically turns in the route of the lower opening portion S4′→the front air passage S2→above the reflector 24→the rear air passage S3→below the lighting circuit unit 60→the lower opening portion S4′. In this way, the light emitting element 22 and the lighting circuit unit 60 are more effectively cooled, as compared to the case of the first embodiment.

Since the other parts are the same as those of the first embodiment and are denoted by the same reference numerals, duplicate explanation thereof will be omitted.

Further, in the first and second embodiments described above, the aiming mechanism E allows the light source unit 20 to be tiltable around the horizontal tilt axis Lx and the vertical tilt axis Ly, respectively. For example, the light source unit 20 may be swung in the horizontal direction around a swivel axis by a swivel mechanism and the optical axis L of the light source unit 20 may be swiveled in the left and right direction in conjunction with the steering of a steering handle.

Further, in the first and second embodiments described above, the heat sinks 30, 30A are disposed such that the horizontal base plate 31a is inclined rearward, and thus, the circulating air convection T vertically turning forward-upward and rearward-downward in the route of the lower air passage S1→the front air passage S2→above the reflector 24→the rear air passage S3→the lower air passage S1 is formed around the heat sinks 30, 30A. In this way, the heat-dissipation effect of the heat sinks 30, 30A is improved. However, the heat sinks 30, 30A may be disposed such that the horizontal base plate 31a is inclined forward, and thus, circulating air convection vertically turning rearward-upward and forward-downward may be formed around the heat sinks 30, 30A. In this way, the heat-dissipation effect of the heat sinks 30, 30A can be enhanced, and the light emitting element 22 and the lighting circuit unit 60 can be effectively cooled.

That is, by arranging the horizontal base plate 31a to be inclined forward, firstly, the movement of heat to the rear side of the heat sink 30 (horizontal base plate 31a) is promoted. Secondly, when the warmed air in the lower air passage S1 ascends along the lower surface of the horizontal base plate 31a inclined forward, the rearward flow of air is generated in the lower air passage S1. In this way, circulating air convection in which the direction of turning is opposite to that of the circulating air convection T formed in the first and second embodiments is formed around the heat sink 30. That is, the circulating air convection vertically turns rearward-upward and forward-downward in the route of the lower air passage S1→the rear air passage S3→above the reflector 22→the front air passage S2→the lower air passage S1.

Further, in the headlamps 10, 10A according to the first and second embodiments described above, the base plate 31 of the heat sinks 30, 30A is formed in the L-shaped longitudinal section including the horizontal base plate 31a and the vertical base plate 31b. However, the base plate 31 of the heat sinks 30, 30A may be constituted by only the horizontal base plate 31a without including the vertical base plate 31b.

That is, the heat-dissipation fins 34 extending on the lower side of the horizontal base plate 31a are formed in a substantially L shape in a side view extending in the front and rear direction beyond the horizontal base plate 31a. Specifically, the lower heat-dissipation fins 34a are continuous with the front heat-dissipation fins 34b extending substantially in the vertical direction to the front lower side of the horizontal base plate 31a and are also continuous the rear heat-dissipation fins 34c, 34d extending substantially in the vertical direction to the rear side of the horizontal base plate 31a in the up and down direction. In this way, the heat-dissipation fins 34 are formed in a plate shape in which the front heat-dissipation fins 34b, the lower heat-dissipation fins 34a and the rear heat-dissipation fins 34c (34d) are integrally continuous.

Further, in the above embodiments, the headlamps 10, 10A in which the light source unit 20 is disposed in the lamp chamber and the light source unit 20 for the headlamps are illustrated. However, the light source unit 20 may be used for a lighting device and lighting equipment such as a flashlight, a ceiling lighting, a spotlight, a search light and a projector. At that time, it is also possible to irradiate light by the projection lens 50 without providing the reflector 24. Further, instead of the reflector 24, a light guiding lens or an optical fiber may be adopted.

1. A vehicle headlamp comprising:
a lamp chamber defined by assembling a front cover at a front opening portion of a container-shaped lamp body;
a light source unit configured such that a light emitting element that is a light source and a reflector that reflects light emitted from the light emitting element toward a front of the lamp chamber are integrally mounted on an upper surface of a metallic base plate constituting a heat sink in cooperation with a plurality of heat-dissipation fins extending from a lower surface of the base plate, the light source unit arranged in the lamp chamber,
wherein the heat-dissipation fins are arranged in parallel in a left and right direction of the base plate and are formed in a substantially L shape in a side view extending in a front and rear direction from a front side of the base plate to a rear upper side of the base plate.

2. The vehicle headlamp according to claim 1,
wherein the base plate is disposed to be inclined forward or rearward.

3. The vehicle headlamp according to claim 2,
wherein the base plate of the heat sink is disposed to be inclined rearward,
front edge portions of the heat-dissipation fins extending on the front side of the base plate are brought into contact with another constituent member of the light source unit disposed adjacent to a front of the heat sink or are integrated with an upright wall extending in the left and right direction, and
a chimney is provided in an air passage constituted by the heat-dissipation fins extending on the front side of the base plate.

4. The vehicle headlamp according to claim 1,
wherein the base plate is formed in an L-shaped longitudinal section,
a vertical rod-shaped portion of the L-shaped longitudinal section of the base plate is formed in a substantially circular arc shape in a plan view surrounding the light emitting element,
out of the plurality of heat-dissipation fins extending rearward from a back side of the vertical rod-shaped portion of the L-shaped longitudinal section of the base plate, at least the heat-dissipation fins closer to both sides in a width direction of the base plate extend in a radial direction with respect to the light emitting element, and
extended ends of the plurality of heat-dissipation fins are arranged along a substantially circular arc shape in a plan view to follow a substantially circular arc shape in a plan view of the vertical rod-shaped portion of the L-shaped longitudinal section of the base plate.

5. The vehicle headlamp according to claim 2
wherein the base plate is formed in an L-shaped longitudinal section,
a vertical rod-shaped portion of the L-shaped longitudinal section of the base plate is formed in a substantially circular arc shape in a plan view surrounding the light emitting element,
out of the plurality of heat-dissipation fins extending rearward from a back side of the vertical rod-shaped portion of the L-shaped longitudinal section of the base plate, at least the heat-dissipation fins closer to both sides in a width direction of the base plate extend in a radial direction with respect to the light emitting element, and
extended ends of the plurality of heat-dissipation fins are arranged along a substantially circular arc shape in a plan view to follow a substantially circular arc shape in a plan view of the vertical rod-shaped portion of the L-shaped longitudinal section of the base plate.

6. The vehicle headlamp according to claim 3
wherein the base plate is formed in an L-shaped longitudinal section,
a vertical rod-shaped portion of the L-shaped longitudinal section of the base plate is formed in a substantially circular arc shape in a plan view surrounding the light emitting element,
out of the plurality of heat-dissipation fins extending rearward from a back side of the vertical rod-shaped portion of the L-shaped longitudinal section of the base plate, at least the heat-dissipation fins closer to both sides in a width direction of the base plate extend in a radial direction with respect to the light emitting element, and
extended ends of the plurality of heat-dissipation fins are arranged along a substantially circular arc shape in a plan view to follow a substantially circular arc shape in a plan view of the vertical rod-shaped portion of the L-shaped longitudinal section of the base plate.

7. A light source unit in which a light emitting element that is a light source is mounted on an upper surface of a metallic base plate constituting a heat sink in cooperation with a plurality of heat-dissipation fins extending from a lower surface of the base plate,
wherein the heat-dissipation fins are arranged in parallel in a predetermined direction of the base plate and are formed in a substantially L shape in a side view extending beyond the base plate in a direction orthogonal to an arrangement direction.
